(19) United States
(12) Patent Application Publication
(10) Pub. No.: US 2023/0168079 A1
(43) Pub. Date: Jun. 1, 2023

(54) METHOD FOR OBTAINING THE PROFILE OF A SURFACE MOVING IN RELATION TO THE SYSTEM

(71) Applicants: COMPAGNIE GENERALE DES ETABLISSEMENTS MICHELIN, Clermont-Ferrand (FR); Centre National De La Recherche Scientifique, Paris (FR); Universite Paul Sabatier, Toulouse III, Toulouse (FR); Institut National Polytechnique De Toulouse, Toulouse (FR)

(72) Inventors: BASTIEN GRIMALDI, CONCA (FR); FLORIAN BREMOND, Clermont-Ferrand (FR); REMI COTE, Clermont-Ferrand (FR); THIERRY BOSCH, Toulouse (FR); FRANCIS BONY, Lavalette (FR); JEAN-MICHEL LOUBES, Pechbusque (FR)

(21) Appl. No.: 17/921,716

(22) PCT Filed: Apr. 27, 2021
(86) PCT No.: PCT/EP2021/060969

§ 371 Date: Oct. 27, 2022

(30) Foreign Application Priority Data
Apr. 27, 2020 (FR) 2004164

(51) Int. Cl. G01B 11/24

(52) U.S. Cl. CPC G01B 11/2441

(57) ABSTRACT

A method for obtaining the profile of the outer surface (22) of a medium (21) having a median plane (23) comprising the following steps: obtaining two time signals A and B (1002), for, at each instant, a same geometrical target on a readout line of the outer surface (22); determining at least one Doppler frequency (2001) associated with each time signal A and B; sampling each time signal A and B (2002) at a frequency greater than 2 times the Doppler frequency to obtain a payload signal; determining an envelope (2004) of the payload signal of each signal A and B; performing a relative combination between the envelopes of each signal A and B (3001) to obtain a monotonic and bijective function F; and determining the profile of the outer surface (3002) using a calibration of the function F.

### FIELD OF THE INVENTION

The present invention relates to a method for obtaining the profile of a surface of a moving object.

### TECHNOLOGICAL BACKGROUND

Knowing the profile of a surface of an object is useful for multiple types of application. First of all, when the object is moving relative to a second object, it is necessary to know this profile to ensure the relative mobility between the two objects. Indeed, it is possible to deduce, from the profile of the surface, the roughness thereof, making it possible to adapt for example the relative speed between the two surfaces so as to ensure a condition of adhesion. Second of all, when inspecting the quality of an object, the profilometry of the surface is a parameter subjected to surveillance since it is a sign of evolution of the manufacturing process, for example. Owing to manufacturing defects but also to ageing or wear in service of the surface of an object or to varying external conditions, it is useful to be able to have regular access to profile information. For example, in the field of land transport, knowing the profile of the ground at a millimetre scale is important for adapting active safety systems of the vehicle to the conditions of ground adhesion, which is dependent on the surface roughness of the ground. Similarly, in the field of object manufacturing, it is useful to measure the profile of the outer surface of manufactured objects to ensure compliance with specifications and to adapt the manufacturing process according to this parameter.

Thus, real-time knowledge of the profile of any surface of an object is important. However, there is a desire for profile-measuring devices that are physically non-intrusive with respect to the object to be evaluated or with respect to the device on which it is likely to be mounted. In addition, the process should have little impact on the current operation of the devices so as not to affect the efficiency of these devices. Finally, it should be potentially economical both in terms of purchase price and in terms of use, and consume little energy.

Among devices for measuring the roughness of the ground, the rugolaser makes it possible to measure profiles dynamically. The measuring principle is based on the use of a pulsed laser source emitting vertically in the direction of the outer surface to be measured. The laser source is coupled to focusing optics and a CCD optical potentiometer or photoreceptor array. Depending on the laser/target distance, the optics focus the image of the point of impact of the laser beam at a given position on the sensor. By locating this position on the potentiometer, it is possible to arrive at the height of the profile of the target.

The drawback of such a device lies in the bulk embedded on the mobile device, its purchase cost and its low measurement flexibility in comparison with the use of the mobile device, since the system settings and the analysis of the measurements require time and post-processing is generally performed after the measurement. It is therefore not possible to obtain the information in real time.

Among devices for measuring surface roughness in terms of quality control for a manufactured object, mention may be made of imaging and lighting devices. However, this type of equipment is not suitable for live quality control since the processing time consumes flow time and the object is generally static or quasi-static. Although it makes it possible to access a three-dimensional observation of the outer surface of the object, this processing being well suited to a quality logic based on random sorting of objects, this is not the case for live quality control of all objects.

The present invention relates to a process for obtaining the profile of a surface on a two-dimensional plane able to be used in real time, solving the problems encountered by processes from the prior art in terms of response time, which means that the process is carried out in a state embedded on the device while at the same time being energy-efficient and resource-efficient.

### DESCRIPTION OF THE INVENTION

The invention relates to a process for obtaining a profile of an outer surface of a medium having a median plane, comprising the following steps:
Obtaining two time signals A and B, deriving from a measurement system having a relative speed V with respect to the outer surface in a direction U, which are the result of the electromagnetic interferences between an incident wave and its wave backscattered by the outer surface along a readout line of at least one electromagnetic wave that is Gaussian, coherent, directional along at least one path and focused in two geometrical positions d1 and d2 on the at least one path and the distance between the two geometrical points is greater than the Rayleigh length, the projection of which with respect to the normal to the median plane of the angle of incidence on each path on the outer surface is greater than one degree in a plane defined by the normal to the median plane and the direction U; for, at each instant, a same geometrical target on the readout line of the outer surface;
Determining at least one Doppler frequency associated with each time signal A and B;
Sampling each time signal A and B at a frequency greater than 2 times, preferentially 10 times, the at least one Doppler frequency to obtain a payload signal;
Determining an envelope of the payload signal of each signal A and B;
Performing a relative combination between the envelopes of each signal A and B to obtain a monotonic and bijective function F; and
Determining the profile of the outer surface using a calibration of the function F.

The invention relates more specifically to a method for obtaining a profile of an outer surface of a medium having a median plane comprising the following steps:
Obtaining two time signals A and B, deriving from a measurement system having a relative speed V with respect to an outer surface having a median plane in a direction U, each signal is the result of the electromagnetic interferences between an incident wave and its wave backscattered by the outer surface along a readout line of at least one electromagnetic wave that is Gaussian, coherent, directional along at least one path and focused at a geometrical point on the at least one path, the two geometrical points d1 and d2 are situated on either side of the median plane, the distance between the two geometrical points is greater than the greatest of the Rayleigh lengths of each wave, with respect to the normal to the median plane, the angle of incidence of the electromagnetic wave along each path on the outer surface is greater than one degree in a plane defined by the normal to the median plane and the direction U; for, at each instant, a same geometrical target on the readout line of the outer surface;
Determining at least one Doppler frequency associated with each time signal A and B;
Sampling each time signal A and B at a frequency greater than twice, preferably 10 times, the at least one Doppler frequency in order to obtain a payload signal;
Determining an envelope of the payload signal of each signal A and B;
Performing a relative combination between the envelopes of each signal A and B in order to obtain a monotonic and bijective function F; and
Determining the profile of the outer surface through a calibration of the function F.

As each signal A and B is the result of the electromagnetic interferences on a single path, the signals A and B are indeed the result of the electromagnetic interferences on at least one path. As each Gaussian and coherent wave is focused on the path at a geometrical point that is distinct from one another such that the first point d1 is situated on one side of the median plane and the other geometrical point on the other side of the median plane, a distance in the vertical direction to the median plane exists between the two geometrical points. Furthermore, as the incidence of the paths is substantially vertical, the distance vertically to the median plane is greater than the greatest Rayleigh length for which the distance between the two waves is greater than the Rayleigh length of the waves along the two paths. Finally, each electromagnetic wave defines an angle of incidence θ along each path to the outer surface with respect to the normal to the median plane of the outer surface.

Here, it is first necessary to have two time signals corresponding, at all times, to the response of the same geometric point of the readout line on the outer surface of the medium under observation. This is illustrated directly by the systems of FIGS. 2 and 3. And, in the case of the system of FIG. 1, it is appropriate beforehand to perform an operation of temporal phasing of the signals deriving from the sensor of the system to take account of the offset X between the two paths. In addition, in the case of the systems of FIGS. 1 and 2, the use of a single sensor with a single electromagnetic wave source requires that the angles of incidence on the outer surface be differentiated while both being greater than 1 degree to extract from the electrical signal from the sensor two time signals each associated with a wave path which is differentiated in terms of Doppler frequency only by the angle of incidence θ. The following steps must be carried out:
Recovering the electrical signal from a sensor i
Extracting from the electrical signal from the sensor the signal associated with the wave beam defined by its angle of incidence θ by selectively filtering the electrical signal around the fundamental and/or harmonics of the Doppler frequency that are associated with the wave beam to obtain a first time signal
Repeating the step for the second Doppler frequency and its associated harmonics to extract a second time signal.

The payload information is carried by the fundamental and the harmonics of the Doppler frequency, which requires a minimum inclination at the arrival of the incident wave on the outer surface. Consequently, it is necessary to determine the Doppler frequency on each signal. This depends on the relative speed V of movement in the direction U between the system and the medium under observation. However, it also depends on the angle of incidence θ with respect to the normal to the median plane of the outer surface. Finally, the Doppler frequency is also a function of the wavelength λ of the electromagnetic wave. Knowing all of these parameters, it is theoretically possible to determine the Doppler frequency, its fundamental. Another solution consists in frequency-analysing the time signal in order to determine the frequency and its harmonics, which should also emerge from the frequency analysis of the signal.

It is thus important that the sampling frequency of the time signals is at least greater than twice the Doppler frequency so that the payload signal carries information that is definitely reliable (signal processing-Shannon's theorem) on the fundamental of the Doppler frequency. However, depending on the application, the information may also be carried by the first harmonics of the Doppler effect; it is then preferable to perform enough sampling to have reliable information on the successive harmonics.

Next, to extract the distance information on the payload signal, it is first necessary to extract the envelope of the payload signal, which represents the extreme temporal variations of the recorded electromagnetic interference. This envelope may be constructed on the minimum value of the payload signal or on the maximum value of the payload signal. As a variant, it is also possible to take the maximum value of the absolute value of the envelope, which generally oscillates around the zero value. Here, it is the amplitude of the signal, through amplitude modulation, that carries the payload information, which justifies taking the envelope of the signal. In addition, this allows rapid processing for extracting the payload information which makes the process easy to implement in a manner embedded in the measurement system.

Finally, the last step is determining the profile along the readout line of the outer surface. For this purpose, a bijective function F is created, this being a relative mathematical combination of the envelopes of the signals resulting from the two paths. The advantage of the relative mathematical combination is that a calibration step may be performed a priori using a target representative of the nature of the media that it is desired to measure. The calibration then does not require the use of conditions similar to the desired measurement, but only requires ensuring the proportionality of the responses between the two signals. The result of this combination gives a quantity that, through a monotonic and bijective function F, translates one and only one distance E relative to a reference point through the step of calibrating the function F, despite this calibration not having not performed on the measurement medium. Real-time measurement of the profile of any outer surface of an unknown medium is thus ensured. The variations in the distance E between the points of the readout line make it possible to automatically generate the profile of this same readout line, thereby allowing real-time processing of the profile, since this requires few computing resources.

Here, the electromagnetic waves which can be light waves for example must be spatially and temporally coherent to obtain interferences between the incident wave and the backscattered wave. Furthermore, the waves must be able to be directional to control the propagation of the waves toward the outer surface and also facilitate the interferences thereof. Finally, it is also necessary to have the faculty to focus the waves at a given geometrical point on the path of the wave and for the electromagnetic wave to be able to be backscattered by the outer surface of the medium. The term “backscattered waves” is understood here to mean that the latter correspond to the incident waves which are reflected and/or scattered by the outer surface and which follow the same path as the incident waves in the reverse direction. Furthermore, it is necessary to have two different geometrical points where the electromagnetic waves are focused in order for the distance between these points to be greater than the Rayleigh length, which is a property of a Gaussian propagation of the waves. This condition ensures that the distances between the outer surface and each geometrical point is sufficiently differentiated for the variations between the signals A and B to be sensitive to the distance variations. Thus, each time signal contains a distinct distance information. Obviously, the wavelength of the electromagnetic waves must be matched to the absorption characteristics of the medium, which allows an optimal backscattering of the waves.

According to one particular embodiment, the step of obtaining two time signals A and B for the same geometric target of the readout line comprises the following steps:
Obtaining two time signals A and B for, at all times, two geometric targets on the readout line of the outer surface;
Establishing the distance X on the median plane along the direction U between the two geometric targets of the readout line;
Determining the relative speed V in the direction U between the measurement system and the outer surface;
Determining the time offset dT between the two time signals associated with the distance X and the speed V; and
Applying at least a portion of the time offset dT to the time signal A and/or to the time signal B.

The system for measuring signals representative of the profile of the outer surface does not necessarily phase the first and second signals with one another, as in the case of FIG. 1. In this case, this preparatory step for the signals is essential for obtaining two time signals from the same point of the readout line of the outer surface in a robust and reliable manner.

Advantageously, the function F is calibrated using at least one white and rough target, the surface roughness of which is greater than the wavelength of the electromagnetic waves.

The use of the function F, a relative mathematical combination of the envelopes of the signals A and B, requires a calibration phase for calibrating this function F. This calibration may be performed using a specific target that is moved metrologically relative to the signal measurement system. This target should advantageously be white and rough. The term “white” is understood to mean here that the outer surface of the target should backscatter electromagnetic waves more than it absorbs them. And the amount that is backscattered should also advantageously be at least equal to or above the level backscattered by the outer surface of the medium that it is desired to measure, thereby guaranteeing the proportionality of the response regardless of the medium to be observed. It is also necessary for this target to have a rough outer surface in order to backscatter and not just reflect the electromagnetic waves as a mirror would. The surface roughness of the target should be greater than the wavelength of the electromagnetic waves. Indeed, if the surface roughnesses are not greater than the wavelength, the surface will behave like a mirror at the wavelength in question, and therefore minimize backscattering. Moreover, the speckle phenomenon, that is to say the phenomenon of electromagnetic and in particular optical speckle, will not be present if the roughness condition is not complied with, and it has to be present in order to be able to optionally characterize speckle noise, that is to say noise generated by the phenomenon of electromagnetic speckle, while still being comparable with that of the targets that it is intended to measure.

Preferably, the step of generating the payload signal comprises the following step:
Filtering, through frequency windowing, each payload signal around the at least one Doppler frequency;

Very preferably, the step of generating the payload signal uses frequency windowing between 0.7 and 1.3 times the Doppler frequency.

It is possible, although not necessary, to filter the time signal around the Doppler frequency that carries the payload information in order to isolate a payload time signal that highlights electromagnetic interference. The uncertainty on the exact Doppler frequency naturally leads to selective filtering being carried out around the determined Doppler frequency. The potential uncertainty on the determination of the Doppler frequency leads to the signal being filtered over a width linked to the Doppler frequency, and the windowing between 0.7 and 1.3 times the determined Doppler frequency makes it possible both to cover the uncertainty on the Doppler frequency while focusing on the only fundamental, which generally carries sufficient information.

Preferably, the step of determining the Doppler frequency is performed through:
A Fourier transform of the payload signal; or
The application of a theoretical formula taking into account the relative speed V along the direction U between the measurement system and the outer surface, the angle of incidence θ of the beam emitted on the median plane of the outer surface and the wavelength λ of the electromagnetic waves, defined as follows:

$$f = \frac{2 * V * sin ( θ )}{λ} ;$$

or
Temporal analysis of the time signal in order to detect the period between two slots or the length of the slot.

These three methods make it possible to determine a Doppler frequency of the time signal. The second method consists simply in theoretically evaluating the Doppler frequency, knowing the technical characteristics of the measurement system. The first method performs a Fourier transform of the time signal in order to extract the fundamental frequency that emerges from the frequency spectrum. If the number of samples of the time signal is a multiple of 2, a fast Fourier transform may be performed, thereby allowing accelerated processing of the function. In the third method, it is necessary to analyse a temporal sample of the signal in order to detect the interference and in particular the spacing between consecutive interference in order to deduce the Doppler frequency therefrom. Of course, it is possible to use several of these methods jointly to converge rapidly on the Doppler frequency of the signal. All of these methods may be performed in a state embedded in the device where the measurement system is installed, minimizing computing or memory resources.

Preferably, the step of determining the envelope of the payload signal is performed on the absolute value of the payload signal.

The applicant has observed that determining the envelope on the payload signal when this corresponds to the absolute value of the payload signal provides an increase in robustness for the method for determining the profile of the outer surface. Indeed, the payload signal oscillates around the zero value, and taking the absolute value eliminates interference related to the phase positions of the two payload signals, thereby improving the prediction of the distance d from the outer surface of the medium.

Very preferably, the step of determining the envelope of each payload signal comprises a step of cleaning speckle noise on the determined envelope.

Indeed, it is often preferable to eliminate speckle effects from the determined envelope, that is to say the effects produced by speckle noise, generated by the Doppler effect and the parasitic signals from the backscattering of the electromagnetic waves. For this purpose, specific filters should be used, such as Lee Sigma or gammaMAP filters, which are highly effective for cleaning the selected signature. This cleaning improves the prediction of the profile of the outer surface of the medium by minimizing noise on the payload signal. Cleaning on the envelope makes it possible to statically attenuate measurement noise while determining the parameters of this cleaning a priori, thereby allowing real-time and on-board use of the profile of the outer surface.

Preferably, the step of cleaning speckle noise on the envelope of the payload signal comprises the following steps:
Determining a time window size and a level of overlap between contiguous windows associated with a filtering method on the system for generating time signals A and B;
Dividing the determined envelope by an integer number N of windows;
Determining a characteristic quantity at each window as being an average of the weighted values of the envelope that are contained in said window; and
Defining the cleaned envelope of each signal as being the succession of characteristic quantities of each window.

In order to allow real-time use of the method for obtaining the profile of the outer surface, simple operations should be performed on the time signals resulting from the measurement. After having defined the filtering method used, which depends both on the nature of the outer surface of the medium to be measured and on the measurement system used, the envelope is divided into a multitude of windows the size of which is adapted to the speckle noise, with or without the windows overlapping with one another depending on the filtering method used. For each window that corresponds to the use of a limited memory space, an average of the values of the envelope of the window is computed. These values are potentially weighted in the event of overlap between contiguous windows. The signal reconstituted by the characteristic quantities of each window forms the envelope cleaned of speckle noise.

Very preferably, the filtering method for the step of cleaning the speckle noise is contained within the group comprising GammaMAP and Sigma.

These are filtering methods for which the effectiveness in terms of characterizing roughnesses of a millimetric outer surface is sufficient by using the measurement systems using light, preferably monochromatic light.

Advantageously, the temporal size of the filtering windows and the level of overlap between contiguous windows are determined during a step of calibrating the speckle noise, comprising the following steps:
Using a white and rough target the surface roughness of which is greater than the wavelength of the electromagnetic waves.
For at least one known position of the target relative to the measurement system;
   Determining the envelope of at least one of the signals A and B;
   Transforming the envelope into the frequency domain in order to obtain a distribution;
Averaging the at least one distribution in order to define a Gaussian speckle distribution related to the generation system;
Defining at least one speckle frequency noise as the product of the Gaussian speckle distribution and a random noise uniformly distributed between 0 and 1;
Applying the at least one speckle noise to a theoretical profile in order to obtain at least one noisy theoretical profile; and
Determining the size of the time window and the level of overlap by minimizing the difference between the theoretical profile and the at least one noisy theoretical profile through statistical analysis.

Indeed, the amplitude of the envelope is at the same time the combination of the reflectivity of the outer surface of the medium at the point of impact of the incident electromagnetic waves, of the distance between the point of impact on the outer surface and the focal or geometric point of the incident electromagnetic waves and speckle noise. This speckle noise is related both to the angles of incidence of the incident beam and the distance between the outer surface and the two geometric points d1 and d2. As a result, the speckle noise is related directly to the layout of the measurement system. The mathematical model of the speckle noise may be the product of a Gaussian frequency distribution and a noise uniformly distributed between 0 and 1. This uniformly distributed noise is statically random, and it is therefore just necessary to identify the correct Gaussian distribution of the frequencies of the speckle noise by calibrating the measurement system. Since the Gaussian distribution is of a certain frequency width, it is necessary to take a sufficient time window so as not to amputate the cleaning operation with an error linked to the time/frequency transformation of the signals. This is tantamount to averaging the time signal of the determined envelope over a time long enough to be statically representative of the speckle noise related to the generation system. The first phase is that of quantifying the speckle noise on the responses of the signals from the measurement system. For this purpose, a single path of the electromagnetic waves may be analysed on a single position of the target. However, it is preferable to increase the number of positions of the target and to analyse the various signals from the measurement system. After having obtained a multitude of envelopes, a Gaussian distribution of these envelopes is determined through a technique of averaging the various distributions obtained. The second step consists in creating a multitude of noisy profiles from a theoretical profile by generating a multitude of speckle noise associated with the generation system. Finally, the optimum time windowing size and the level of overlap between the contiguous windows are determined using statistical analysis on all the noisy profiles in comparison with a known theoretical profile by choosing the parameters that minimize the differences on the entire population of noisy profiles.

Advantageously, the step of combining the cleaned envelopes comprises the difference between the cleaned envelopes expressed on a logarithmic scale.

The applicant has observed that this formatting of the mathematical combination of the cleaned envelopes made it possible to improve the sensitivity of the function F, thereby improving the precision on the evaluation of the distance d from the outer surface of the medium. Due to the Gaussian propagation of the electromagnetic waves and therefore the backscattered power, the logarithmic scale makes it possible to linearize the backscattered power as a function of the distance from the focal or geometric point of the electromagnetic waves. The function F is linear in a manner more independent of the position of the geometric points and of the focusing of the electromagnetic waves.

### BRIEF DESCRIPTION OF THE DRAWINGS

The invention will be better understood on reading the following description in the case of an application involving a fixed device and moving medium under observation. This application is given solely by way of example and with reference to the appended figures, in which:

FIG. 1 is a first example of a first embodiment of a measurement system according to the invention.

FIG. 2 is a second, preferred example of the first embodiment according to the invention.

FIG. 3 is an example of a second embodiment of a generation system according to the invention.

FIG. 4 is an overview of the method for evaluating the profile of the outer surface of a medium using signals coming from the measurement system.

FIGS. 5a to 5f illustrate the various steps and the quality of the method for evaluating the profile of an outer surface dynamically and in real time.

### DETAILED DESCRIPTION OF EMBODIMENTS

To implement the invention, it is first necessary to define an optical system that makes it possible to generate two light beams the focal point of which is located on either side of the outer surface that it is desired to observe.

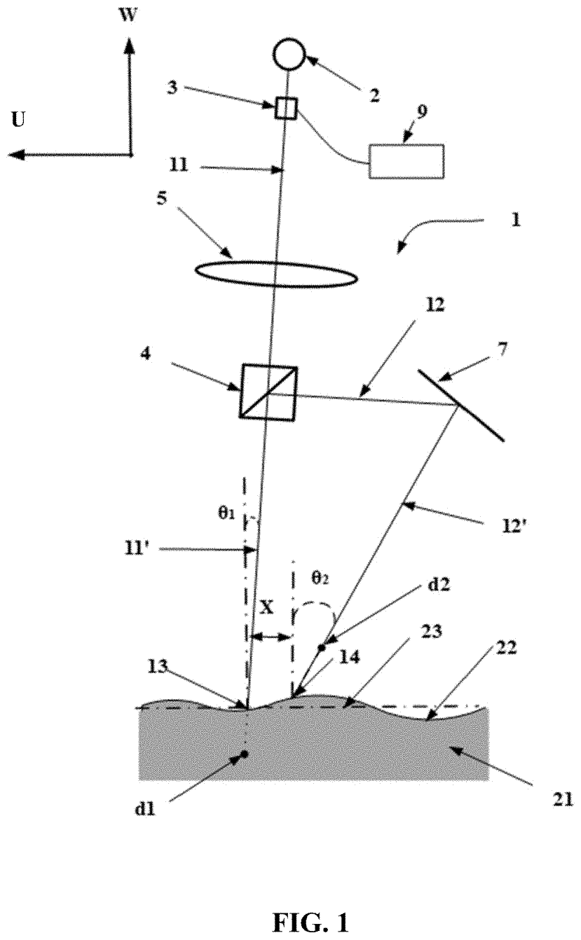

FIG. 1 shows a first system 1 for measuring a signal representative of the profile of the outer surface 22 of the medium 21 using, as electromagnetic wave, light waves. The outer surface 22 defines a median plane 23 for which the points of the surface are statically evenly distributed on either side of the median plane 23. This median plane 23 defines a normal direction that is characterized, in the figure, by an straight line alternating between dotted lines and dashes, located vertically in the direction W. The figure shows a sectional view of the outer surface 22 in a plane defined by the direction U of movement of the medium 21 relative to the static device on which the measurement system 1 is installed. The optical paths 11′ and 12′ draw, on the outer surface 22, a readout line along the direction U.

The term “optical distance” is understood to mean the succession of the contiguous spatial positions followed by the light beam between a light source 2 or a means for generating a light beam and the outer surface 22 of the medium 21 under observation.

The term “optical path” is understood to mean at least a part of an optical distance between the last focusing lens 5 or 6 of the light beam before the outer surface 22 and the point furthest away between the outer surface 22 and the focusing point d1 or d2 of the light beam.

In this FIG. 1, the generation system 1 corresponds to a first embodiment, in which a single light source is used. A laser source 2 emits a first Gaussian beam of monochromatic coherent light at a wavelength λ along a first optical distance 11 defined by the unbroken line coming from the source 2. This first light beam passes through a light sensor 3 in the outward direction before encountering a first focusing lens 5 with a focal length f1. At the exit of the first focusing lens 5, the light is focused at a focusing distance f1 along any optical path.

The first optical path 11′ resulting from the first light beam having passed through the first focusing lens 5 is then divided into 2 through a splitter cube 4, for example 50/50. The light power is thus split into two equal portions, and each half-power is directed in two different directions. The splitter cube 4 is the means for generating a second light beam from the first light beam along a second optical distance 12, which is identical to the second optical path 12′. It therefore retains its characteristics of the first light beam. The second light beam is thus Gaussian, coherent and monochromatic at the same wavelength as the first light beam. Moreover, it is generated from a focused light beam, and the second optical path 12′ is thus created. The mirror 7 here acts as a means for routing along the second optical path 12′. Its first role is to direct the second light beam towards the outer surface 22 at an angle of incidence the angular projection of which with respect to the normal to the median plane 23 in the plane defined by the normal to the median plane 23 and the direction U is equal to θ2, which is preferably less than 45 degrees while necessarily being non-zero. The second role of the mirror 7 is to define the position of the geometric point d2 such that this point is different from the geometric point d1 where the first optical path 11′ is focused. Therefore, the geometric point d2 corresponding to the focusing distance f2 of the second light beam is located above the median plane 23 of the outer surface 22 of the medium 21. This second light beam impacts the outer surface 22 at the point of impact 14 at an angle of incidence the projection of which, in the plane, is equal to θ2.

The other remaining half-power follows the first optical path 11′ and impacts the outer surface 22 at the point of impact 13 at an angle of incidence the projection of which with respect to the normal to the median plane 23 in the plane defined previously is equal to θ1, which is greater than 1 degree. For this portion of the first light beam, the focusing distance f1 and the first optical path 11′ define a first geometric point d1 located below the median plane 23 of the outer surface 22. Here, the two points of impact 13 and 14 corresponding respectively to the meeting of the first optical path 11′ and, respectively, of the second optical path 12′ with the outer surface 22 are spaced apart by a distance X in the direction U. Obviously, the two focusing points could have been situated above the outer surface. However, this configuration improves the sensitivity of the method for obtaining the profile by profiting from the fact that the focusing point can be virtual. In fact, those are discarded, which reinforces the profile measurement accuracy.

A portion of the first and second incident light beams are backscattered by the outer surface 22 at each of the points of impact 13 and 14. A portion of this backscattered light follows the path opposite to the incident optical path. In particular, the two light beams recombine after the splitter cube 4 so as to jointly continue their route towards the light source 2 and necessarily passing through the light sensor 3. The meeting of the first incident beam and the backscattered beam generates electromagnetic interference as long as these two beams are mutually coherent.

This measurement system 1 according to the first embodiment, using a single light source 2, but also equipped with a single light sensor 3, delivers only a single electrical signal at the output of the light sensor 3, which it directs towards the electronic device comprising the signal amplifier 9. The light sensor 3 should be capable of translating the electromagnetic interference that arises at this light sensor 3 into an electrical signal. The location of the light sensor 3 on the first optical distance is unimportant, but it is preferable to position it where the sum of the two light beams generates the smallest beam size in order to optimize interference.

In order to dissociate, on the single electrical signal from the light sensor 3, the information resulting from the interference of the first and second light beams, it is preferable for the information to be easily detectable. However, the payload information is carried here in particular by the fundamental of the Doppler frequency and its harmonics. The Doppler frequency is theoretically dictated by three parameters. The first corresponds to the relative speed V in the direction U between the medium 21 and the device on which the generation system 1 is mounted. The second is the angle of incidence θ between the light beam and the normal to the outer surface 22, which will be taken as being that of the median plane 23. The third is the wavelength λ of coherent light. Here, only the angle of incidence θ of the light beam is able to generate an effective parameter to dissociate the two Doppler frequencies. Indeed, the other two parameters are potentially identical by design of this measurement system 1. Therefore, the first and second angles of incidence with respect to the normal to the median plane 23, and reference is made here to their projection in the plane defined above, are different, thereby making it possible to dissociate the Doppler frequencies from one another.

Finally, in order for the signals from each light beam to be able to be used to determine the distance d from the outer surface 22, and thereby allow the reconstruction of the profile of the outer surface 22 along the readout line, it is necessary to separate the two geometric points d1 and d2 by a length greater than the greatest Rayleigh length of the two Gaussian light beams. Indeed, the Gaussian propagation of light ensures that the amount of light backscattered is proportional to the distance between the focal point of the light beam and the outer surface 22 where the backscattering takes place. In fact, the energy will be at a maximum if the outer surface 22 is located at the focal point. The further one moves away from it, the more the backscattered light energy decreases following a Gaussian curve, thereby providing a measurable dynamic range on electromagnetic interference. Ensuring a sufficient spacing between the two focal points ensures that a combination of the electromagnetic interference measured on each channel makes it possible to deduce the distance d from the outer surface 22.

It is possible to observe electromagnetic interference through the self-mixing phenomenon, or optical feedback phenomenon, by using a laser source as light source 2, equipped for example with a photodiode as light sensor 3. The temporal record of the output signal from the photodiode is then an image of the interference of light between the incident beam and the beam backscattered by the outer surface. The temporal variations are due both to the distance between the focal point d and the outer surface 22 and the reflectivity of the outer surface 22. The information is partly carried by the Doppler frequency related to the relative speed V between the medium 21 and the measurement system 1. By ensuring two measurement channels each corresponding to a light beam pointing to the same readout line of the outer surface 22 the focal point of which is different, the two measurement channels are each the result of the reflectivity of the outer surface 22 and the distance between the focal point and the outer surface 22. The combination of the two channels makes it possible to make the result of the two channels insensitive to the reflectivity of the outer surface 22 and to be dependent only on the distance of the two focal or geometric points from the outer surface 22.

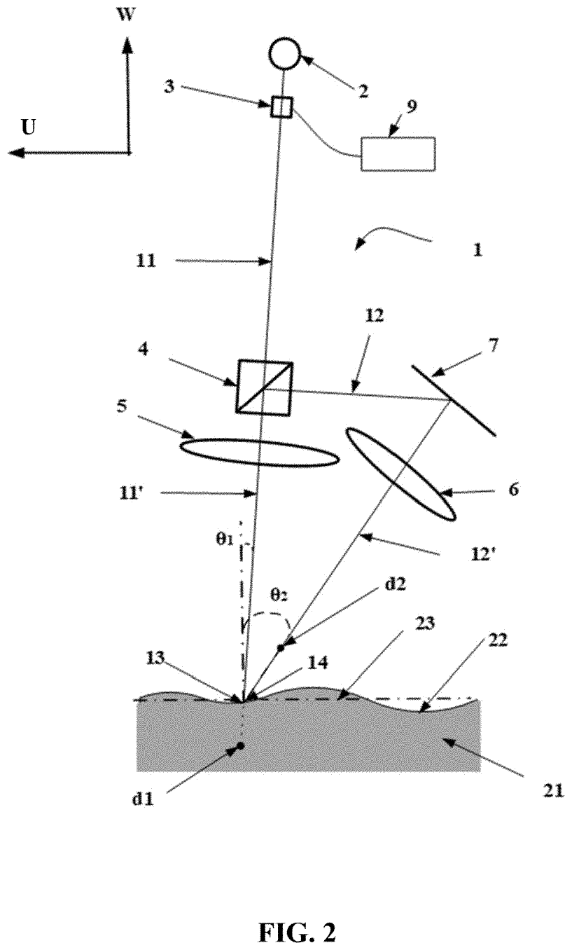

FIG. 2 is an illustration of another example of a measurement system 1 according to the first embodiment; this is the preferred example of this embodiment. This time, the first light beam from the first light source 2 is focused using a focusing lens 5 located downstream of the first optical device 4. Once again, this optical device 4 also acts as a means for generating a second beam of Gaussian, coherent and monochromatic light. This second light beam is due to the splitting of the light power of the first Gaussian beam through the splitter cube 4. This delivers a first portion of the first light beam towards the outer surface 22 of the medium 21 at an incidence such that the projection θ1 of the angle of incidence with respect to the normal along the median plane 23 of the outer surface 22 is greater than one degree. Prior to the point of impact 13 on the outer surface 22, the light beam is focused by the focusing lens 5 at a focal length f1 such that the geometric point d1, which is the focal point f1 along the first optical distance 11, is a virtual point located in the medium 21. Thus, at this incidence, a portion of the light beam is subject to the Doppler effect, and the backscattered beam then carries Doppler information that will be used to determine the distance d from the outer surface.

Similarly, the second light beam, which is the other portion of the first light beam, follows a second optical distance towards the outer surface 22 of the medium 21. Here, the means for routing this second light beam comprises a mirror 7 that redirects the second light beam towards the outer surface 22. On the second optical distance is located a second focusing lens 6, the focal length f2 of which focuses the second light beam at the geometric point d2 located above the median plane 23. The point of impact 14 of the second light beam along the second optical path is identical to the first point of impact 13 of a portion of the first light beam. Only the projection θ2 of the angle of incidence of the second light beam on the outer surface 22 with respect to the normal to the median plane 23 differs from the projection θ1.

In this FIG. 2, the measurement system 1 comprises just a single light sensor 3 located on the first optical distance of the first light beam. This is connected to a signal amplifier 9 so as to make the electrical signal delivered by the sensor 3 usable. The sensor 3 records electromagnetic interference of the first and second light beam. These carry information about the Doppler frequencies of each light beam. These frequencies are dependent on the wavelength of the monochromatic light, the speed of movement V and the angle of incidence in the direction U. Due to differences in the angle of incidence, the information carried by each of the light beams may easily be dissociated. Indeed, the ratio of the projection angles is around 1.5. In addition, the angles of incidence are both contained within a cone the axis of revolution of which is carried by the normal to the median plane 23, the aperture angle of which is less than 30 degrees and the apex of which is located on the median plane 23 of the outer surface

In order that the backscattered beam from the second optical path interferes as little as possible with the electromagnetic interference between the first light beam and its backscattered beam at the first light sensor 3, it is preferable for the two light beams downstream of their focusing lens, that is to say on their optical path, not to intersect before the outer surface. This is a precaution to be taken for any measurement system 1 of the first embodiment having a single light source 2.

Here, the two points of impact 13 and 14 of the first 11 and second 12 optical paths are coincident. This avoids any time correction between the two coupled signals at the light sensor 3. The two signals will thus be able to be used directly in order to deduce therefrom the distance d from the outer surface 22 of the medium 21, thereby allowing faster real-time processing. In addition, the use of a single sensor does not require any synchronization of the signals, also limiting small errors, thereby reducing noise on the signals.

This is the preferred set-up of the first embodiment due to the absence of these time corrections on the signals, which speeds up the processing of the signals and limits noise on the signals. In addition, it is an inexpensive set-up since a single light source and a single sensor are used.

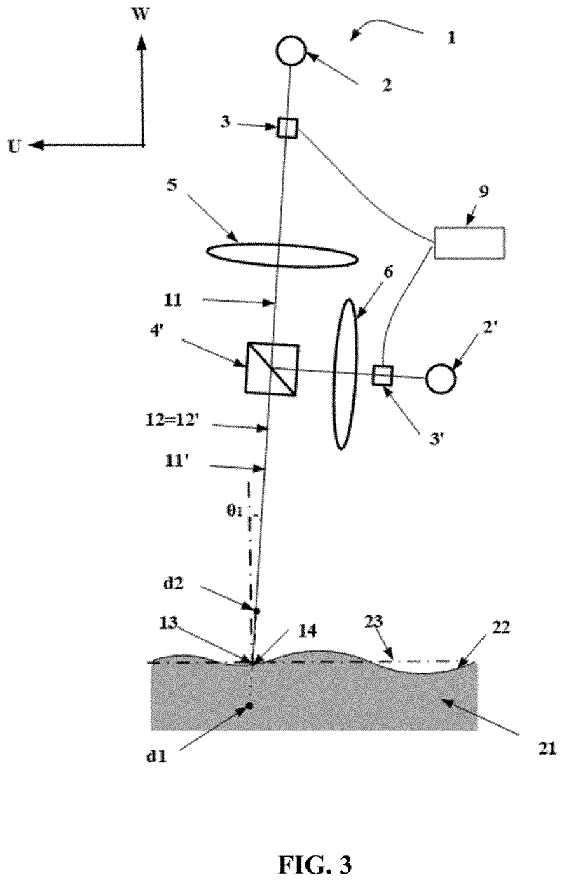

FIG. 3 presents a first example of a measurement system 1 according to the second embodiment, that is to say comprising two light sources 2 and 2′. This time, the first light beam from the first light source 2 is focused using a focusing lens 5 situated upstream of a first optical device 4′ along the incident route of the light. However, the second light beam is, for its part, generated by a second light source 2′ delivering also a light beam that is Gaussian, coherent and monochromatic. This second light beam is focused using a second focusing lens 6 situated upstream of the first optical device 4′.

This time, this optical device 4′ redirects the first focused light beam toward the outer surface 22 of the medium 21 along a first optical path 11. This optical device 4′ also acts as a routing means for the second focused light beam by redirecting the latter toward the outer surface 22 of the medium 21 over a second optical path 12. However, this optical device 4′ essentially makes it possible to merge the two light beams into just one, which guarantees that the two optical paths 11 and 12 are identical after the incident beams have passed through the optical device 4′, which is an optical cube merging the beams that are initially not parallel. Thus, the first and second light beams converge toward the outer surface 22 of the medium 21 by an incidence such that the projection θ of the angle of incidence with respect to the normal along the median plane 23 of the outer surface 22 is greater than one degree. Thus, with this incidence, the backscattered beam is subjected to the Doppler effect provoked by the speed of displacement V between the device comprising the measurement system 1 and the medium 21 in the direction U. However, since the geometrical points d1 and d2 for each of the light beams are wanted to be situated on either side of the median plane, it is sufficient for that to relatively displace the two focusing lenses 5 and 6 on their respective optical paths 11 and 12 for the focal distance f1 and f2 of each of the lenses to define different geometrical points d1 and d2. It is also possible to employ focusing lenses 5 and 6 whose focusing distances f1 and f2 differ so as to define the different geometrical points.

Here, the measurement system 1 comprises two light sensors 3 and 3′ associated respectively with the first and second optical distances. Each light sensor 3 and 3′ records the electromagnetic interferences between the incident light beam and its beam backscattered by the outer surface 22 of the medium 21.

The light sources 2 and 2′ are physically dissociated, so the light beams from one cannot be coherent with the light beams from the other which limits the interferences between the first and second light beams. Thus, the measured electromagnetic interferences are linked to a single light source whatever the wavelength of the light source 2 and 2′.

The two electrical signals from each light sensor 3 and 3′ are synchronized in the electronic device comprising a signal amplifier. The signals require no temporal correction since they have the same point of impact 13 and 14 on the outer surface 22.

Here, this second embodiment is economically interesting if the light sources are conventional laser diodes having, in their amplifying cavity, an integrated photodiode which serves as light sensor 3 or 3′. The packaging is then concentrated and inexpensive allowing economical operation of the measurement system 1. Indeed, when a single light source is employed as in the case of the first embodiment, the use of a laser source other than a diode can be envisaged. It is also possible to use the amplifying cavity of the laser as a preferred spatial zone for observation of the electromagnetic interferences. The use of a light sensor in the form of a photodiode or phototransistor linked with the amplifying cavity can be envisaged as can the observation of the power supply parameters of the laser source using an ammeter or a voltmeter if the laser source is not equipped with an electronic regulation of its power supply.

Obviously, these examples of the two embodiments are concrete applications of a measurement system for time signals A and B. For all that, these measurement systems 1 would not be limited to these examples. In particular, any combination of the features of these examples can be envisaged and falls within the general framework of a measurement system 1 delivering two time signals which is the result of the electromagnetic interferences which are a function of the distance d between the focusing point and the outer surface of the medium and of the reflectivity of the outer surface to the light waves in these examples. For all that, it is possible to imagine a same measurement system 1 with magnetic or electrical waves.

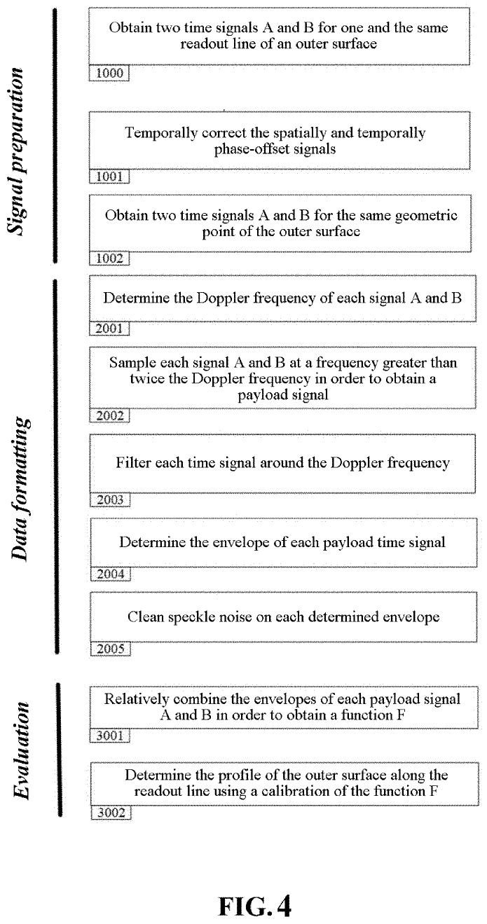

FIG. 4 is an overview of the method for evaluating the distance d of the outer surface from a reference potentially implementing one of the measurement systems 1 described previously moving at a relative speed V with respect to the medium 21 in a direction U. However, this method is not otherwise intended to be limited to signals output from this generation system.

FIG. 4 comprises three main phases. The first concerns the preparation of electrical signals, for example at the output of the measurement system. The second phase concerns the implementation of these signals in order to perform the third phase, which is the actual evaluation of the distanced from the outer surface. Of course, this first phase is optional if a measurement system directly generates two signals with respect to known references for the same geometric point of a readout line of the outer surface. This system is for example the second embodiment of the measurement system of FIG. 3 or the preferred example of the first embodiment of FIG. 2.

The first phase comprises a first step 100 consisting in obtaining two time signals A and B representative of the profile of the outer surface with respect to a readout line. These may for example be the output of the electronic device of the measurement system. Of course, in this step, it is not certain that the two signals are temporally and spatially phased, which means having to go through the next step 1001. For example, these two points are separated along the readout line of the outer surface by a spacing X, as in the example of FIG. 1.

The second step 1001 corresponds to the spatio-temporal correction to be applied to one and/or the other of the time signals A and B from step 1000. For this purpose, it is necessary to know the method for obtaining the two time signals, that is to say the spatio-temporal spacing between the two measurement points each corresponding to a time signal with respect to a common reference. The spatial position may be a metric position that is obtained visually, for example. The time offset may be the date of crossing in front of a reference point serving for example as a common reference, through a clock signal with a metric for each signal. In addition, it is useful to know the scrolling speed along the readout line of the outer surface associated with each time signal. All of these data make it possible to define a correction matrix to spatio-temporally recalibrate the two signals on one and the same geometric point of the readout line. Applying this correction to the time signals from step 1000 gives the result of step 1002, which ends the signal preparation phase.

The second phase corresponds to formatting of the measured data, which are represented by the time signals obtained in step 1002 from the first phase. The principle of the method according to the invention is that the payload information of the time signals is contained in the fundamental and the harmonics of the Doppler frequency associated with the relative speed V of the medium 21 with respect to the time signal measurement system. This is independent of the physical means for measuring the signals, whether this be light, sound or any other electromagnetic wave.

The first step 2001 consists in defining the Doppler frequency associated with the relative speed V. The Doppler frequency may be determined using a mathematical formula such as the formula linking the relative speed V, the angle of incidence with respect to the normal to the outer surface and the wavelength of the light. It may also result from analysing the signals, whether this analysis be temporal or frequency analysis. Knowing this Doppler frequency, it is necessary for the sampling frequency of the time signals to be at least twice as great as the Doppler frequency, complying with the condition of Shannon's Theorem, in order to ensure that the information of the time signals is plausible and not induced by uncertainty related to the measurement conditions, this corresponding to step 2002. Optionally, it may prove useful to filter the time signals around the Doppler frequency identified in step 2001, and this may be carried out for example over a wide band of between 0.7 and 1.3 times the Doppler frequency. Thus, depending on the mode for identifying the Doppler frequency, theoretically or through frequency analysis of the signals or through temporal analysis of the signals, and also the potential slow evolution of the relative speed V, the Doppler frequency is not necessarily determined in absolute terms, and a wide window then makes it possible to cover all of these uncertainties by isolating the usable information, this corresponding to step 2003. Of course, if the frequency interference related to the signal measurement system is low, it is entirely conceivable to take the complete signal without selective filtering and move directly to step 2004.

Step 2004 consists in focusing on the general signal carrying the information through the envelope of the payload signal. It is expected that this will be an image of the events related to the Doppler frequency associated with the relative speed V. In step 2004, the envelope of the payload time signal is determined, potentially driven by a narrow frequency band around the Doppler frequency. Of course, the envelope of the payload signal may be constructed from the minima, the maxima or the absolute value of the payload signal. The choice of method depends on the nature of the measured signals with respect to the physical quantity under observation.

Optionally, in order to statically eliminate parasitic noise on the envelope of the measured time signal, speckle cleaning is carried out in order to extract the precise information therefrom in step 2005. This makes it possible to statistically eliminate measurement randoms caused by lack of compliance with the conditions for an ideal measurement. This is carried out through a learning campaign on a known target representative of the outer surface of the medium that it is desired to observe using the envisioned measurement system. This learning phase determines a Gaussian distribution of the measurement randoms, which should be coupled with an evenly distributed noise in order to determine a speckle noise. This makes it possible to determine the time windowing of the payload signal that should be taken into account in order to clean the speckle noise by applying the identified Gaussian distribution. Step 2005 consists in removing the determined speckle noise from the envelope signal in order to obtain a cleaned envelope on each measurement channel. This step ends the second data formatting phase.

The last phase is evaluating the variation in the distance d of the outer surface from a reference, making it possible to deduce the profile of the outer surface. This comprises a first step 3001, which consists in mathematically combining the envelopes obtained in steps 2004 or 2005 so as to define a function F that is bijective. The bijectivity of the function F makes it possible to guarantee the uniqueness of the distance d from the outer surface using the information from the two envelopes. In the case of self-mixing, or optical feedback, with Gaussian and coherent light beams, defining the function F as being the difference between the envelopes expressed on a logarithmic scale ensures both monotony and good sensitivity of the function F over the distance range separating the two geometric points d1 and d2 of the measurement system. Precision is enhanced by taking the absolute value of the payload signal to construct the envelopes. Of course, the precision improves when taking the cleaned envelopes.

Finally, to arrive at a relative distance d between various points of the readout line of the outer surface with respect to a reference geometric position, it is necessary to establish a calibration between the result of the function F as defined in step 3001 and a target the position of which is known with respect to the geometric points of the measurement system, this corresponding to step 3002. This makes it possible to convert the response of the function F into a known metric quantity.

To this end, a calibration step should be undertaken using the measuring device, directly or indirectly delivering the time signals A and B with respect to two different geometric points d1 and d2. In the case of the measurement system presented, the two geometric points are the points d1 and d2 where each of the light beams are focused and located on either side of the median plane of the outer surface of the medium. It is entirely possible to position these two geometric points above the outer surface to extrapolate the distance to the outer surface, by assuming a continuous evolution of the bijective function F. Here, the calibration is performed using a target the physical response of which is at least as strong as the outer surface of the medium that it is desired to observe. In the case of the measurement system in general, it is necessary to use a white target, that is to say having very high reflectivity with respect to the observation medium. Thus, for our illustration with a physical quantity which is a monochromatic light, the majority of the incident light is thus backscattered by the surface, which absorbs a very small proportion thereof. In addition, in order to observe light scattering, the target should be rough. However, in order not to be penalized by a large degree of integration between the light from the generation system and the target, the surface roughness of the target should be greater than that of the medium under observation. It is then sufficient to calibrate the measurement system by moving the target between the geometric points d1 and d2 in a known manner and to identify the value of the corresponding function F using the envelopes. This calibration will be used in step 3002 to obtain the distance d from the outer surface of the system. Here, the function F is insensitive to the backscattered power, since the function F is a relative combination of the signal envelopes, such as the linear scale ratio or the logarithmic scale difference. If the combination of the envelopes is absolute, it will be necessary to perform a more precise calibration using a target the physical properties of which are similar to those of the medium that it is desired to observe using the measuring device according to the metric used: light or electromagnetic waves.

The optional speckle noise correction is also performed using the same target as in the signal calibration step. This time, the number of time measurements is increased by moving the target, knowing the result to be achieved in order to evaluate the distribution of the measurements around the reference value. For this purpose, the distribution of the measurements is evaluated in the frequency domain under diversified measurement conditions on a large time sample. This frequency distribution is modelled by a centred Gaussian. The width of this Gaussian determines the minimum size of the measurement time window, so that the Gaussian distribution is statistically representative. The speckle noise is then evaluated through the product of the Gaussian frequency distribution and a noise uniformly distributed between 0 and 1. This speckle noise is to be subtracted from the determined envelope in order to obtain a measurement that depends in the first order only on the reflectivity of the target or the outer surface of the medium under observation. Proportionality is assumed between the reflectivity of the target and that of the outer surface of the medium to be observed, which will be transparent due to the relative combination of the envelopes.

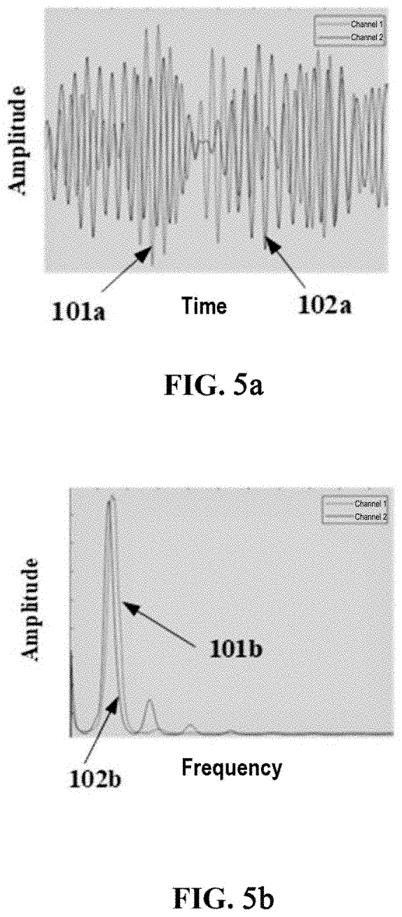

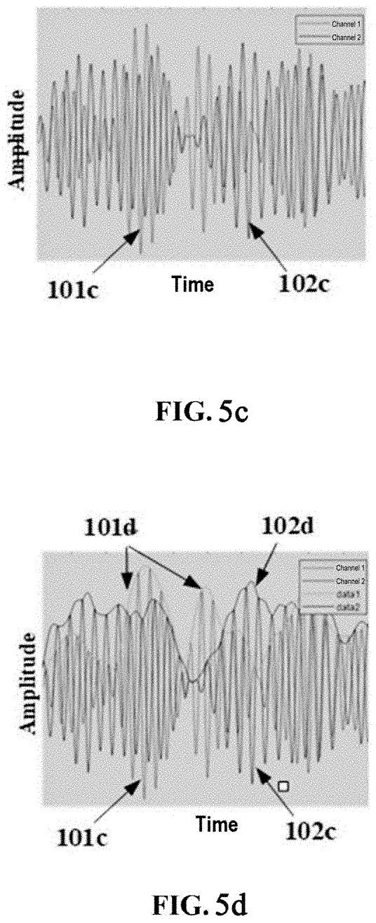

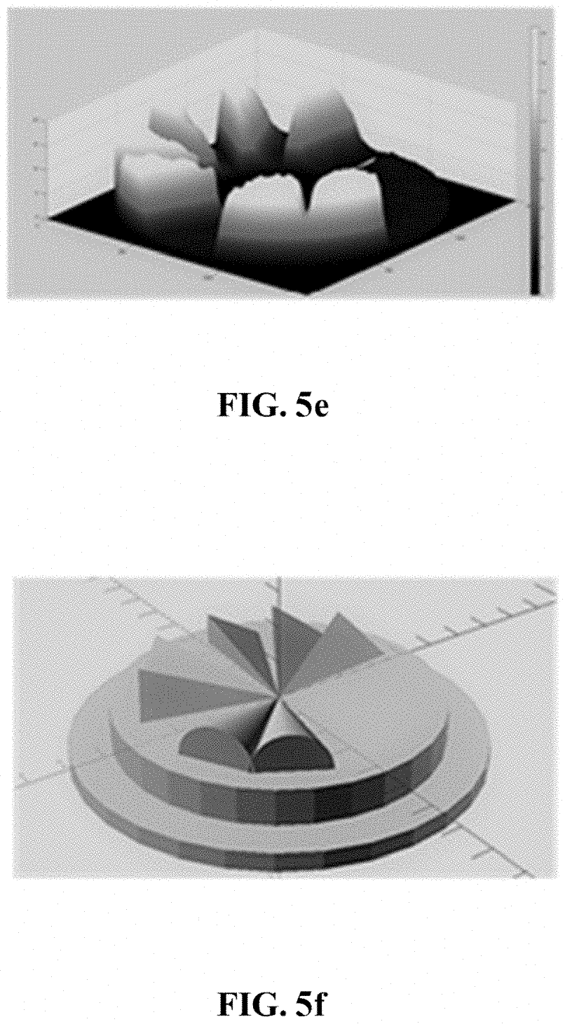

FIGS. 5a to 5e illustrate the method for measuring the profile of an outer surface of a test specimen, for which FIG. 5e shows the three-dimensional reconstruction obtained by photographic means using specific lighting. This circular test specimen has a profile, in the direction of its axis, that evolves non-monotonically as a function of the azimuth. And a proportional evolution of this profile is defined according to the radius from the centre of the circular test specimen. This is mounted on a rotary shaft rotating at an angular speed of the order of 1550 rpm. Finally, the rotary shaft is moved in a translational movement along a direction X, allowing the centre of the circular test specimen to move in translation. The surface roughness of the test specimen is of the order of millimetres with regard to the masses covering 75 percent of the test specimen. The last quarter of the test specimen resembles a smooth surface with a surface roughness of the order of around ten micrometres.

To apply the method, use was made of a preferred measurement system according to the second embodiment, the principle of which is illustrated in FIG. 3. It is a measurement system comprising two distinct light sources, of which the light power is merged into a single optical path intended for the outer surface of the test specimen. The angle of incidence of the first and second light beams on the outer surface of the test specimen is identical while being contained within a cone with an aperture angle of less than 30 degrees, such that the projection of these angles of incidence with respect to the normal to the median plane of the outer surface in a plane defined by this normal and the direction U of movement of the test specimen is around 5 degrees. In addition, it is ensured that the two light beams have the same point of impact on the outer surface, thereby limiting the corrections to be made to the interferometric signals on the two optical paths. In fact, the readout line on the outer surface of the test specimen is a succession of circles centred on the centre of the circular disk of the test specimen, each circle corresponding to a different translational position of the rotary shaft on which the test specimen is mounted.

The measurement system comprises, as light source, a laser diode equipped with a photodiode at the entrance of the amplifying cavity of the laser diode. The laser diode emits a beam of coherent, monochromatic light at the single wavelength and the propagation of which along the direction of the beam is Gaussian. Here, the wavelength of the first laser diode is centred on 1350 nanometres. The second, meanwhile, is centred on 1500 nanometres. The photodiode associated with each laser diode records the electromagnetic interference between the incident light beam and the light beam backscattered by the outer surface of the test specimen. The electromagnetic interference of the first optical path is mainly carried by the harmonics of the first Doppler frequency related directly to the first wavelength, which is inversely proportional to the wavelength. On the other hand, the electromagnetic interference of the second optical path is carried by the harmonics of the second Doppler frequency, the Doppler frequency of which is lower than the first Doppler frequency. The differentiation of the geometric points d1 and d2 where the first and second optical paths are collimated is defined by the length of the optical paths. Here, the first optical path towards the outer surface is defined by the first focusing lens through its position on the first optical path and its focal length. The second optical path comprises a mirror, integrated into the optical merging element in order to redirect the second light beam towards the outer surface of the test specimen. The geometric point d2 is controlled directly by the positioning and the focal length of the second focusing lens of the generation system. Thus, at the output of the electronic device, two electrical signals each associated with a photodiode are obtained, containing the payload information carried by the harmonics of each different Doppler frequency. It should be noted that if identical laser diodes are used on the first and second light sources, the same output signals from the generation system would always be obtained because of the coherence of the light beam from each diode which limits the interferences between the light beams.

The measurement is carried out by fixing the measurement system on a static device located in line with the test specimen such that the geometric points d1 and d2 are located on either side of the outer surface of the test specimen. In our case, they are equidistant from the median plane of the outer surface of the test specimen, at a distance of around 5 millimetres. The spacing between the geometric points is thus of the order of a centimetre, which is less than the variations in the profile of the outer surface of the test specimen, while being greater than the Rayleigh length of the first and second Gaussian light beams.

FIG. 5a shows the temporal evolution in terms of amplitude of two signals. The first signal 101a comes from the photodiode associated with the first light source, and the second signal 102a comes from the photodiode associated with the second light source. Here, the observed interference expresses amplitude modulations of the time signal around a carrier. The succession of fronts is related directly to the interference, which evolves with the position of the points of impact of the light beams on the outer surface of the surface.

FIG. 5b is the frequency spectrum of the time signals from FIG. 5a for each of the signals. The first response spectrum 101b is mainly characterized by a mass centred on the first Doppler frequency. The second curve 102b is characterized by a succession of harmonics associated with the second Doppler frequency. The two Doppler frequencies are slightly offset in terms of frequency. Regardless of the spectral response of the signals, the fundamental frequency carries most of the energy of the signal. In addition, it is possible to note an emergence on each signal at very low frequency, which is similar to a structural mode of the device or of the generation system used. Indeed, this emergence appears on both spectra. Therefore, the temporal response is marred by the signature of the static device or of the measurement system, and should be eliminated.

FIG. 5c shows time signals 101c and 102c that correspond to the signals 101a and 102a, respectively, by filtering its signals over a narrow frequency band around the fundamental Doppler frequency of each signal. These corrected time signals eliminate the vibrational contribution of the structural mode of the static device or of the measurement system. The frequency band is between 0.7 and 1.3 times the Doppler frequency, although a wider band could have been suitable, such as for example between 0.5 and 1.5 times the Doppler frequency. The spectral signature of each time signal with harmonics of the Doppler frequency, which are relatively unused, allows such a correction without causing a loss of information on the electromagnetic interference observed by the photodiodes. If the information is also carried by the harmonics, the harmonics should be taken into account by way of the filtering step.

FIG. 5d shows the definition of the envelopes 101d and 102d based on the filtered time signals 101c and 102c. Here, the envelopes 101d and 102d are constructed on the maxima of the time signals 101c and 102c.

Finally, a surface profile illustrated in FIG. 5e is reconstructed by combining the previously obtained envelopes 101d and 102d. Since the time signals are obtained in-phase during acquisition, no spatio-temporal correction step needs to be performed on the time signals. Here, the profile is constructed at each time sample, by taking the difference between the logarithms of the amplitudes of the envelopes 101d and 102d. Due to the spacing between the geometric points and the formation of the waists of the laser; the term “waist” is understood to mean the width of the laser beam at the focal point, at the geometric points, bijectivity of the abovementioned combination makes it possible to associate a single distance D with each combination. The distance D is measured with respect to any real or notional reference point of the measuring device. Here, for the profile, only the relative position of one sample with respect to another is of interest, regardless of the reference point. The distance D is obtained from a calibration phase of calibrating the measuring device using a white circular target the surface roughness of which is greater than the wavelengths of the first and second light beams. The cylindrical surface has a cylindrical outer surface the profile of which evolves with the radius of the cylinder and does not vary with the azimuth of the cylinder. The relative combination of the envelopes obtained using the method corresponding to the bijective function F is then compared with the altitude of the profile of the target.

FIG. 5f is the three-dimensional reconstruction of the test specimen after post-processing of the images obtained by multiple static cameras and depending on specific lighting. This reconstruction should be compared with the image in FIG. 5e. It is possible to note a similarity of the profiles between the measurement obtained using the method and the static reconstruction on the global and local level. Indeed, local imperfections may be observed in the second order, which corresponds to the spacing between two measurement circles of the test specimen. Simply smoothing the points makes it possible to overcome this problem.

1-12. (canceled)

13. A method for obtaining a profile of an outer surface (22) of a medium (21) having a median plane (23) comprising the following steps:
obtaining two time signals A and B (1002) for, at each instant, a same geometrical target on a readout line of the outer surface (22), from a measurement system (1) having a relative speed V in a direction U with respect to the outer surface (22) having the median plane (23), each signal being the result of electromagnetic interferences between an incident wave and the incident wave backscattered by the outer surface (22) along the readout line of at least one electromagnetic wave that is Gaussian, coherent, directional along at least one path (11, 12) and focused at a geometrical point (d1, d2) on the at least one path (11, 12), the two geometrical points d1 and d2 being situated on either side of the median plane (23) and, the distance between the two geometrical points d1 and d2 being greater than a greatest of the Rayleigh lengths of each electromagnetic wave, with respect to the normal to the median plane (23), and the angle of incidence (θ1, θ2) of the electromagnetic wave along each path (11, 12) on the outer surface (22) being greater than one degree in a plane defined by a normal to the median plane (23) and the direction U;
determining at least one Doppler frequency (2001) associated with each time signal A and B;
sampling each time signal A and B (2002) at a frequency greater than 2 times the at least one Doppler frequency to obtain a payload signal;
determining an envelope (2004) of the payload signal of each signal A and B;
performing a relative combination between the envelopes of each signal A and B (3001) to obtain a monotonic and bijective function F; and
determining the profile of the outer surface (3002) using a calibration of the function F.

14. The method for obtaining the profile of the outer surface (22) of a medium (21) according to claim 13, wherein the calibration of the function F is performed using at least a white and rough target, the surface roughness of which is greater than a wavelength of the electromagnetic waves.

15. The method for obtaining the profile of the outer surface of a medium according to claim 13, wherein the step of obtaining two time signals A and B (1002) for the same geometrical target of the readout line comprises the following steps:
obtaining two time signals A and B (1000) for, at each instant, two geometrical targets on the readout line of the outer surface (22);
establishing a distance X on the median plane in the direction U between the two geometrical targets of the readout line;
determining the relative speed V in the direction U between the measurement system and the outer surface;
determining a temporal offset dT between the two time signals associated with the distance X and the speed V; and
applying at least a part of the temporal offset dT (1001) to the time signal A and/or to the time signal B.

16. The method for obtaining the profile of the outer surface of a medium according to claim 13, wherein the step of determining the Doppler frequency (2001) is performed by:
a Fourier transform of the time signal; or
application of a theoretical formula taking account of the relative speed V in the direction U between the measurement system and the outer surface, the angle of incidence θ of the beam transmitted on the median plane of the outer surface and the wavelength λ of the electromagnetic waves defined as follows:
$$f = \frac{2 * V * sin ( θ )}{λ} ;$$
or
an analysis of the time signals to detect the period between two pulses or pulse length.

17. The method for obtaining a profile of the outer surface of a medium according to claim 13, wherein the step of generation of the payload signal (2002) comprises the following step:
filtering, by frequency windowing, each payload signal around the at least one Doppler frequency (2003).

18. The method for obtaining the profile of the outer surface of a medium according to claim 17, wherein the step of generation of the payload signal (2002) employs a frequency windowing between 0.7 and 1.3 times the Doppler frequency.

19. The method for obtaining the profile of the outer surface of a medium according to claim 13, wherein the step of determining the envelope of the payload signal (2004) is performed on an absolute value of the payload signal.

20. The method for obtaining the profile of the outer surface of a medium according to claim 13, wherein the step of determining the envelope of each payload signal (2004) comprises a step of cleaning of the speckle noise (2005) on the determined envelope.

21. The method for obtaining the profile of the outer surface of a medium according to claim 20, wherein the step of cleaning of the speckle noise (2005) on the envelope of the payload signal comprises the following steps:
determining a time window size and a level of overlap between the contiguous windows associated with a filtering method on the system for generating the time signals A and B;
subdividing the determined envelope by an integer number N of windows;
determining a quantity characteristic to each window as being an average of the weighted values of the envelope contained in the window; and
defining a cleaned envelope of each signal as being the succession of the characteristic quantities of each window.

22. The method for obtaining the profile of the outer surface of a medium according to claim 21, wherein the filtering method of the step of cleaning of the speckle noise (2005) is selected from GammaMAP and Sigma.

23. The method for obtaining the profile of the outer surface of a medium according to claim 21, wherein the determination of the temporal size of the filtering windows and the level of overlap between the contiguous windows is performed in a step of calibration of the speckle noise comprising the following steps:
employing a white and rough target a surface roughness of which is greater than the wavelength of the first and second light beam;
for at least one known position of the target with respect to the system for generating the representative signal, determining the envelope of at least one of the signals A and B and transforming the envelope into the frequency domain to obtain a distribution;
averaging the at least one distribution to define a Gaussian distribution of speckle linked to the generation system;
defining at least one speckle frequency noise as the product of the Gaussian distribution of speckle by a random noise uniformly distributed between 0 and 1;
applying the at least one speckle noise to a theoretical profile to obtain at least one noisy theoretical profile; and
determining a size of the time window and a level of overlap by minimizing a difference between the theoretical profile and the at least one noisy theoretical profile through statistical analysis.

24. The method for obtaining the profile of the outer surface of a medium according to claim 13, wherein the step of relative combination of the envelopes (3001) comprises determining the difference between the envelopes expressed on a logarithmic scale.
